(19) United States
(12) Patent Application Publication
(10) Pub. No.: US 2021/0181051 A1
(43) Pub. Date: Jun. 17, 2021

(54) DIFFERENTIAL PRESSURE MEASURING INSTRUMENT

(71) Applicant: Azbil Corporation, Tokyo (JP)

(72) Inventors: Ayumi Tsushima, Tokyo (JP); Tomohisa Tokuda, Tokyo (JP); Yoshiyuki Ishikura, Tokyo (JP); Kenji Yao, Tokyo (JP); Koichi Ochiai, Tokyo (JP)

(21) Appl. No.: 17/111,991

(22) Filed: Dec. 4, 2020

(30) Foreign Application Priority Data
Dec. 12, 2019 (JP) 2019-224262

(51) Int. Cl. G01L 13/02; G01L 19/00; G01F 1/34

(52) U.S. Cl. CPC G01L 13/025; G01F 1/34; G01L 19/0038

(57) ABSTRACT

A chip that constitutes a pressure-sensitive sensor and an enclosure are provided. The enclosure is formed with a sensor placement chamber in which the chip is placed. In the sensor placement chamber in which the chip is housed, a first pipe connecting a first communication channel on the side of the sensor placement chamber to a first pressure introduction portion and a second pipe connecting a second communication channel on the side of the sensor placement chamber to the second pressure introduction portion are provided. A side surface of the first pipe and a side surface of the second pipe are disposed out of contact with an inner wall of the sensor placement chamber.

### CROSS-REFERENCE TO RELATED APPLICATION

The present application claims the benefit of and priority to Japanese Patent Application No. 2019-224262, filed on Dec. 12, 2019, the entire contents of which are incorporated by reference herein.

### TECHNICAL FIELD

The present invention relates to a differential pressure measuring instrument.

### BACKGROUND

In the related art, differential pressure measuring instruments for industrial use include a chip of the sensor element made of silicon or other materials, which is built in an enclosure made of metal such as SUS to be protected from corrosive measurement objects and the measurement environment. Such a differential pressure gauge configured as described above includes oil, or the like, enclosed as a pressure transmitting medium to transfer pressure to a chip housed in an interior thereof (see PTL 1).

### CITATION LIST

### Patent Literature

[PTL 1] JP-A-H03-048128

### SUMMARY

The differential pressure measuring instrument described above may be affected by heat transfer from the measurement object and measurement environment during actual measurement, and the temperature of the enclosure and the enclosed pressure transmitting medium may rise in some cases. In such cases, in the past, the temperature of the chip (sensor element) built into the enclosure rises with the rise in temperature of the enclosure and the pressure transmitting material. Since the heat resistance temperature of electronic components such as sensor elements is not very high, in the related art, a region where the temperature rise can be suppressed has been established in the interior of the enclosure, and the chips are placed in this region to alleviate the effects of heat. Alternatively, the enclosure is provided with a structure (for example, heat-dissipating fins, embedded insulation material, etc.) that suppresses heat transfer to a part where the chip is embedded. To provide the enclosure with this structure, the differential pressure measuring instruments of the related art are not easy to miniaturize while sufficiently protecting the chip from heat, for example.

To solve the problem described above, it is an object of the present invention to miniaturize a differential pressure measuring instrument including a chip of a sensor element built in an enclosure.

A differential pressure measuring instrument according to the present invention comprises: a chip constituting a pressure-sensitive sensor comprising a first diaphragm and a second diaphragm, and a first pressure introduction portion and a second pressure introduction portion that cause a pressure transmitting material to act on the first diaphragm and second diaphragm, respectively; an enclosure comprising a first barrier diaphragm provided on a first side surface, and a second barrier diaphragm provided on a second side surface, the enclosure being formed with a first pressure chamber and a second pressure chamber isolated from an exterior by the first barrier diaphragm and the second barrier diaphragm, respectively, a sensor placement chamber in which the chip is disposed, and a first communication channel and a second communication channel communicating the first pressure chamber and the second pressure chamber with the sensor placement chamber, respectively; a first pipe connected at one end thereof to the first communication channel on a side comprising the sensor placement chamber, and at the other end thereof to the first pressure introduction portion of the chip housed in the sensor placement chamber; and a second pipe connected at one end thereof to the second communication channel on a side comprising the sensor placement chamber, and at the other end thereof to the second pressure introduction portion of the chip housed in the sensor placement chamber.

In one configuration example of the differential pressure measuring instrument described above, a side surface of the first pipe and a side surface of the second pipe are not in contact with an inner wall of the sensor placement chamber.

In one configuration example of the differential pressure measuring instrument described above, the chip is supported by the first pipe and the second pipe and is separated from the inner wall of the sensor placement chamber.

One configuration example of the differential pressure measuring instrument described above further comprises a package disposed in the sensor placement chamber and configured to house the chip.

In one configuration example of the differential pressure measuring instrument described above, the chip is in contact with the inner wall in an interior of the package only in a part of a region of an outer surface of the chip, and a remaining region of the outer surface of the chip is separated from the inner wall of the package.

One configuration example of the differential pressure measuring instrument described above further comprises a pressure transmitting material filled in the first pressure introduction portion, the first pipe, the first communication channel, and the first pressure chamber, and a pressure transmitting material filled in the second pressure introduction portion, the second pipe, the second communication channel, and the second pressure chamber.

In one configuration example of the differential pressure measuring instrument described above, the chip comprises a first strain gauge provided on the first diaphragm and a second strain gauge provided on the second diaphragm.

As described above, according to the present invention, the first pipe connected to the first pressure introduction portion of the chip and the second pipe connected to the second pressure introduction portion of the chip for transmitting pressure from the pressure transmitting material are used to support the chip in the sensor placement chamber in the interior of the enclosure, and thus miniaturization of the differential pressure measuring instrument comprising the chip of the sensor element built in the enclosure is achieved while sufficiently protecting the chip from heat.

### BRIEF DESCRIPTION OF THE DRAWINGS

FIG. 1 is a cross-sectional view illustrating a configuration of a differential pressure measuring instrument according to an embodiment of the present invention.

FIG. 2 is a cross-sectional view illustrating a partial configuration of the differential pressure measuring instrument according to the embodiment of the present invention.

FIG. 3 is a cross-sectional view illustrating a partial configuration of the differential pressure measuring instrument according to the embodiment of the present invention.

FIG. 4 is a cross-sectional view illustrating a configuration of another differential pressure measuring instrument according to the embodiment of the present invention.

### DETAILED DESCRIPTION

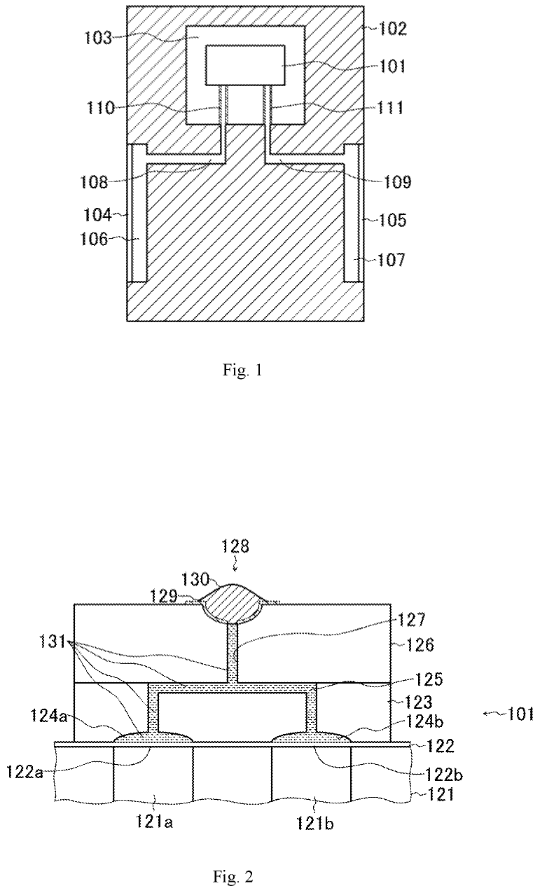

Referring now to FIG. 1, a differential pressure measuring instrument according to an embodiment of the present invention will be described. The differential pressure measuring instrument comprises a chip 101 that constitute a pressure-sensitive sensor, and an enclosure 102. The enclosure 102 is made of, for example, metal.

The enclosure 102 is formed with a sensor placement chamber 103 in which the chip 101 is placed. An interior of the sensor placement chamber 103 is made airtight, and, for example, nitrogen gas is enclosed therein. The enclosure 102 also comprises a first barrier diaphragm 104 provided on a first side surface and a second barrier diaphragm 105 provided on a second side surface.

The enclosure 102 is formed with a first pressure chamber 106 and a second pressure chamber 107 isolated from the exterior by the first barrier diaphragm 104 and the second barrier diaphragm 105, respectively. The enclosure 102 is formed with a first communication channel 108 and a second communication channel 109, which communicate the first pressure chamber 106 and the second pressure chamber 107 with the sensor placement chamber 103, respectively.

As illustrated in FIG. 2, the chip 101 comprises a base 126, a part 123 joined to a back surface of the base 126, a diaphragm layer 122 joined to the part 123, and a part 121 attached to the part 123 via the diaphragm layer 122. The base 126, the part 123, the diaphragm layer 122, and the part 121 are made of Si. The base 126 is also formed with a depression 128 on a main surface thereof. The depression 128 is formed with a metal layer 129 on a front surface thereof.

The depression 128 is in communication with an oil storage part such as a communication channel 125 formed in the part 123, a diaphragm chamber 124a, and a diaphragm chamber 124b via a through-hole 127 penetrating through the base 126. Oil, serving as the pressure transmitting material, is fed from the depression 128, and oil 131 as the pressure transmitting material is filled within the oil storage part, such as the communication channel 125, the diaphragm chamber 124a, and the diaphragm chamber 124b via the through-hole 127. After filling the oil 131 in this manner, a solder ball (ball solder) is placed on top of a metal layer 129 in the depression 128 and heated and melted. This causes the through-hole 127 to be sealed with a sealing member 130.

The part 121 is also formed with a first pressure introduction portion 121a and a second pressure introduction portion 121b, which are arranged at positions overlapping with the diaphragm chamber 124a and the diaphragm chamber 124b across the diaphragm layer 122. Regions of the diaphragm layer 122, which are interposed between the diaphragm chamber 124a and the first pressure introduction portion 121a and interposed between the diaphragm chamber 124b and the second pressure introduction portion 121b, correspond to the first diaphragm 122a and the second diaphragm 122b, respectively. The first pressure introduction portion 121a and the second pressure introduction portion 121b are disposed on the same side with respect to the part 121 (chip 101).

In the sensor placement chamber 103 in which the chip 101 described above is housed, the differential pressure measuring instrument comprises a first pipe 110 connecting the first communication channel 108 on the side of the sensor placement chamber 103 to the first pressure introduction portion 121a, and a second pipe 111 connecting the second communication channel 109 on the side of the sensor placement chamber 103 to the second pressure introduction portion 121b.

A side surface (pipe wall) of the first pipe 110 and a side surface (pipe wall) of the second pipe 111 are disposed out of contact with an inner wall of the sensor placement chamber 103. The chip 101 is supported by the first pipe 110 and the second pipe 111 and is disposed out of contact with (separated from) the inner wall of the sensor placement chamber 103.

In the differential pressure measuring instrument, pressure received by the first barrier diaphragm 104 is transferred to (and acts on) the first diaphragm 122a by a pressure transmitting material that fills the first pressure chamber 106, the first communication channel 108, the first pipe 110, and the first pressure introduction portion 121a, and deforms the first diaphragm 122a. The pressure received by the second barrier diaphragm 105 is transmitted to (and acts on) the second diaphragm 122b by a pressure transmitting material that fills the second pressure chamber 107, the second communication channel 109, the second pipe 111, and the second pressure introduction portion 121b, and deforms the second diaphragm 122b.

Note that an electrode, not illustrated, is formed on the diaphragm layer 122 in a region, not illustrated, extending around the part 123. Although not illustrated, the first diaphragm 122a and the second diaphragm 122b are provided with a first strain gauge and a second strain gauge for measuring the strain of the first diaphragm 122a and the second diaphragm 122b, respectively, that are deformed by the application of pressure. Each of the first strain gauge and the second strain gauge comprises, for example, a plurality of piezoresistive elements, and the plurality of piezoresistive elements constitute a bridge circuit. The bridge circuit functions, when stress is generated in the first diaphragm 122a and the second diaphragm 122b in a state in which a constant current flows therein, as a differential pressure detection part that outputs a change in resistance value of each piezoresistive element due to the generated stress as a change in voltage. Each node of the bridge circuit is connected to an electrode via a wiring pattern formed on a surface of the region, not illustrated, in the diaphragm layer 122.

According to the differential pressure measuring instrument according to the embodiment described above, since the chip 101 is housed in the sensor placement chamber 103 at a position separated from the inner wall thereof, the heat of the enclosure 102 is suppressed from conducting to the chip 101. The sensor placement chamber 103 may be configured to hermetically seal the interior in a vacuum (reduced pressure) state, and such a configuration allows the conduction of heat as described above to be further suppressed. Since heat conduction can be suppressed in this manner, there is no need to provide in an interior of the enclosure 102 with a region in which the temperature rise can be suppressed, and there is no need to embed insulation material, or the like, to suppress heat transfer to the location in which the chip 101 is built-in, so that the enclosure 102 having a smaller size can be used. As a result, according to the embodiment, miniaturization of the differential pressure measuring instrument is achieved.

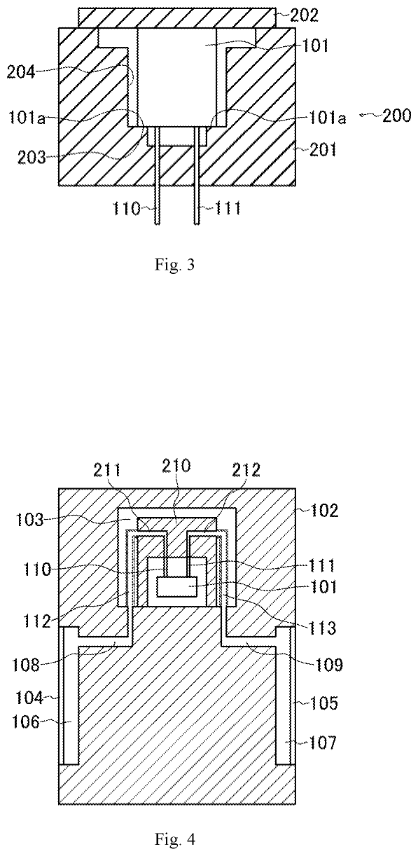

The chip 101 may also be housed in a package 200 and disposed in the sensor placement chamber 103 as illustrated in FIG. 3. The package 200 comprises a package body 201 and a lid 202. An interior of the package 200 (package body 201) where the chip 101 is housed is filled with, for example, nitrogen gas and is sealed by the lid 202.

The chip 101 is in contact with an inner wall (chip fixing portion 203) of the interior of the package 200 (package body 201) in only part of a region of an outer surface of the chip 101 (fixing portion 101a), and the other regions of the outer surface of the chip 101 are separated from the inner wall of the package 200. For example, as illustrated in FIG. 3, the chip 101 is fixed at the fixing portion 101a in a periphery of a bottom surface thereof to the chip fixing portion 203 in the interior of the package 200, and the surface (side surface) of the chip 101 other than at the fixing portion is separated from an inner wall 204 of the package 200. The fixation is implemented by a predetermined adhesive material. Note that the package 200 may house an electronic part for characterization (characteristic identification) of a pressure-sensitive sensor of the chip 101 along with the chip 101.

As illustrated in FIG. 4, a chip storage structure 210 can be provided in the sensor placement chamber 103, and the chip 101 can be placed in an interior of the chip storage structure 210. The chip storage structure 210 has, for example, a cylindrical shape. One opening end side of the chip storage structure 210 having a cylindrical shape is fixed to an interior surface of the enclosure 102 of the sensor placement chamber 103 on a side where the first barrier diaphragm 104 and the second barrier diaphragm 105 are disposed.

The chip storage structure 210, having a cylindrical shape, is provided at a closed-end portion on the other side with a first communication hole 211 and a second communication hole 212 for communicating an exterior and an interior. The first pipe 110 is connected at one end thereof to the first communication hole 211 on the interior side of the chip storage structure 210, and the other end of the first pipe 110 is connected to the first pressure introduction portion 121a. The second pipe 111 is connected at one end thereof to the second communication hole 212 on the interior side of the chip storage structure 210 and the other end of the second pipe 111 is connected to the second pressure introduction portion 121b.

In the interior of the chip storage structure 210, the chip 101 is supported by the first pipe 110 and the second pipe 111 and is separated from the inner wall of the chip storage structure 210. At the closed end portion of the chip storage structure 210, planes where interior side opening ends of the first communication hole 211 and the second communication hole 212 are disposed to face toward the side of the enclosure 102 where the first barrier diaphragm 104 and the second barrier diaphragm 105 are disposed. Accordingly, in contrast to the differential pressure measuring instrument described using FIG. 1, in the differential pressure measuring instrument described using FIG. 4, the chip 101 is arranged upside down with respect to the enclosure 102.

Note that an end of the first communication channel 108 on the side of the sensor placement chamber 103 and the first communication hole 211 on an exterior side are connected with a third pipe 112. Likewise, an end of the second communication channel 109 on the sensor placement chamber 103 side and the second communication hole 212 on the exterior side are connected with a fourth pipe 113.

As described above, according to the present invention, the first pipe connected to the first pressure introduction portion of the chip and the second pipe connected to the second pressure introduction portion of the chip for transmitting pressure by the pressure transmitting material are used to support the chip in the sensor placement chamber in the interior of the enclosure, so that the chip is separated from the inner wall of the sensor placement chamber, which allows the heat of the enclosure to be suppressed from conducting to the chip. Consequently, according to the present invention, the differential pressure measuring instrument containing the chip of the sensor element built in the enclosure can be miniaturized while sufficiently protecting the chip from the heat.

It is apparent that the present invention is not limited to the embodiment described above and that many variations and combinations can be implemented within the technical concept of the present invention by persons having ordinary knowledge in the art.

### DESCRIPTION OF REFERENCE NUMERALS AND SIGNS

101: chip, 102: enclosure, 103: sensor placement chamber, 104: first barrier diaphragm, 105: second barrier diaphragm, 106: first pressure chamber, 107: second pressure chamber, 108: first communication channel, 109: second communication channel, 110: first pipe, 111: second pipe, 121a: first pressure introduction portion, 121b: second pressure introduction portion, 122: diaphragm layer, 122a: first diaphragm, 122b: second diaphragm, 131: oil

1. A differential pressure measuring instrument comprising:
a chip constituting a pressure-sensitive sensor comprising
a first diaphragm and a second diaphragm, and
a first pressure introduction portion and a second pressure introduction portion that cause a pressure transmitting material to act on the first diaphragm and second diaphragm, respectively;
an enclosure comprising
a first barrier diaphragm provided on a first side surface,
a second barrier diaphragm provided on a second side surface,
the enclosure being formed with a first pressure chamber and a second pressure chamber isolated from an exterior by the first barrier diaphragm and the second barrier diaphragm, respectively,
a sensor placement chamber in which the chip is disposed, and
a first communication channel and a second communication channel communicating the first pressure chamber and the second pressure chamber with the sensor placement chamber, respectively;
a first pipe connected, at one end, to the first communication channel on a side comprising the sensor placement chamber and, at another end, to the first pressure introduction portion of the chip disposed in the sensor placement chamber; and
a second pipe connected, at one end, to the second communication channel on a side comprising the sensor placement chamber and, at another end, to the second pressure introduction portion of the chip disposed in the sensor placement chamber.

2. The differential pressure measuring instrument according to claim 1, wherein
a side surface of the first pipe and a side surface of the second pipe are not in contact with an inner wall of the sensor placement chamber.

3. The differential pressure measuring instrument according to claim 1, wherein
the chip is supported by the first pipe and the second pipe and is separated from the inner wall of the sensor placement chamber.

4. The differential pressure measuring instrument according to claim 1, further comprising:
a package disposed in the sensor placement chamber and configured to house the chip.

5. The differential pressure measuring instrument according to claim 4, wherein
the chip is in contact with the inner wall in an interior of the package only at a region of an outer surface of the chip, and other regions of the outer surface of the chip are separated from the inner wall of the package.

6. The differential pressure measuring instrument according to claim 1, further comprising:
a pressure transmitting material filled in the first pressure introduction portion, the first pipe, the first communication channel, the first pressure chamber, the second pressure introduction portion, the second pipe, the second communication channel, and the second pressure chamber.

7. The differential pressure measuring instrument according to claim 1, wherein the chip comprises:
a first strain gauge provided on the first diaphragm, and
a second strain gauge provided on the second diaphragm.
